(19) United States
(12) Patent Application Publication
(10) Pub. No.: US 2026/0281952 A1
(43) Pub. Date: Sep. 17, 2026

(54) REVERSE POSITIONING OF ACCESS POINTS USING MULTI-TECHNOLOGY MEASUREMENTS

(71) Applicant: QUALCOMM Incorporated, San Diego, CA (US)

(72) Inventors: Varun Amar REDDY, San Diego, CA (US); Alexandros MANOLAKOS, Athens (GR); Krishna Kiran MUKKAVILLI, San Diego, CA (US)

(21) Appl. No.: 19/471,934

(22) PCT Filed: Apr. 16, 2024
(86) PCT No.: PCT/US2024/024731

§ 371 Date: Oct. 2, 2025

(30) Foreign Application Priority Data
Jun. 1, 2023 (GR) 20230100437

(51) Int. Cl. H04W 64/00

(52) U.S. Cl. CPC H04W 64/00

(57) ABSTRACT

Techniques are provided for positioning wireless devices such as access points and other wireless nodes. An example method for determining a location of an access point includes obtaining positioning measurement results based on radio frequency signals transmitted or received between the access point and a plurality of wireless nodes, obtaining a location estimate for each of the plurality of wireless nodes, determining quality metrics associated with the positioning measurement results, selecting a subset of the positioning measurement results based at least in part on the quality metrics associated with the positioning measurement results, and determining the location of the access point based on the subset of the positioning measurement results and the location estimates for the plurality of wireless nodes associated with the subset of the positioning measurement results.

### CROSS-REFERENCE TO RELATED APPLICATION

This application claims the benefit of Greek Patent Application No. 20230100437, filed Jun. 1, 2023, entitled “REVERSE POSITIONING OF ACCESS POINTS USING MULTI-TECHNOLOGY MEASUREMENTS,” which is assigned to the assignee hereof, and the entire contents of which are hereby incorporated herein by reference for all purposes.

### BACKGROUND

The use of wireless devices for many everyday activities is becoming common. Modern wireless devices may make use of one or more wireless communication technologies. For example, a wireless device may communicate using a short range communication technology such as WiFi technology, Bluetooth®, technology, ultrawideband (UWB) technology, millimeter wave (mmWave) technology, etc. The use of short range communication technologies, such as WiFi and Bluetooth®, in wireless devices has become much more common in the last several years and is regularly used in retail businesses, offices, homes, cars, manufacturing operations, and public gathering places. Access points may be installed to enable data communication between wireless devices and a network. Some access points may enable access to the Internet. Short range communication technologies may be used in ranging and radio frequency sensing operations. The use of access points in ranging and positioning applications, however, is often limited because the locations of access points is often unknown to other wireless nodes in a network.

### SUMMARY

An example method for determining a location of an access point according to the disclosure includes obtaining positioning measurement results based on radio frequency signals transmitted or received between the access point and a plurality of wireless nodes, obtaining a location estimate for each of the plurality of wireless nodes, determining quality metrics associated with the positioning measurement results, selecting a subset of the positioning measurement results based at least in part on the quality metrics associated with the positioning measurement results, and determining the location of the access point based on the subset of the positioning measurement results and the location estimates for the plurality of wireless nodes associated with the subset of the positioning measurement results.

Implementations of such a method may include one or more of the following features. At least one of the quality metrics may be an uncertainty value associated with the location estimate for at least one of the plurality of wireless nodes. At least one of the quality metrics may be a signal-to-noise ratio value of a positioning measurement result. At least one of the quality metrics may include an indication of a hardware configuration of at least one of the plurality of wireless nodes. Selecting the subset of the positioning measurement results may include comparing the quality metrics to one or more threshold values. At least one of the plurality of wireless nodes may be an user equipment. At least one of the plurality of wireless nodes may be an access point. The method may include obtaining a coarse location estimate for the access point, and determining a bounding area around the coarse location estimate, wherein determining the quality metrics for the positioning measurement results is based at least in part on an intersection of the positioning measurement results with the bounding area.

Determining the location of the access point may include providing the subset of the positioning measurement results to a server and receiving the location of the access point from the server. One or more positioning reference signals transmitted from a transmission/reception point may be measured and the positioning reference signal measurement information may be provided to the server.

An example method for prioritizing positioning measurement results according to the disclosure includes obtaining positioning measurement results associated with a plurality of wireless nodes, determining one or more quality metrics associated with each of the positioning measurement results based at least in part on a measurement technology associated with a respective positioning measurement result, comparing the one or more quality metrics for each of the positioning measurement results to one or more quality threshold values; and storing a positioning measurement result as a prioritized positioning measurement result in response to the one or more quality metrics satisfying at least one quality threshold value.

Implementations of such a method may include one or more of the following features. The stored prioritized positioning measurement result may be provided to a server. Location estimates for each of the plurality of wireless nodes may be obtained, such that at least one of the one or more quality metrics includes an uncertainty value associated with a location estimate for at least one of the plurality of wireless nodes. At least one of the one or more quality metrics may be a signal-to-noise ratio value of a positioning measurement result. At least one of the one or more quality metrics may include an indication of a hardware configuration of at least one of the plurality of wireless nodes. The measurement technology associated with the respective positioning measurement result may includes one of an ultrawideband (UWB) technology, a Wi-Fi technology, or a Bluetooth® technology. At least one of the plurality of wireless nodes may be an access point.

An example apparatus according to the disclosure includes at least one memory, at least one transceiver, at least one processor communicatively coupled to the at least one memory and the at least one transceiver, and configured to: obtain positioning measurement results based on radio frequency signals transmitted or received between an access point and a plurality of wireless nodes, obtain a location estimate for each of the plurality of wireless nodes, determine quality metrics associated with the positioning measurement results, select a subset of the positioning measurement results based at least in part on the quality metrics associated with the positioning measurement results, and determine a location of the access point based on the subset of the positioning measurement results and the location estimates for the plurality of wireless nodes associated with the subset of the positioning measurement results.

An example apparatus according to the disclosure includes at least one memory, at least one transceiver, at least one processor communicatively coupled to the at least one memory and the at least one transceiver, and configured to: obtain positioning measurement results associated with a plurality of wireless nodes, determine one or more quality metrics for each of the positioning measurement results based at least in part on a measurement technology associated with a respective positioning measurement result, compare the one or more quality metrics for each of the positioning measurement results to one or more quality threshold values, and store a positioning measurement result as a prioritized positioning measurement result in response to the one or more quality metrics satisfying at least one quality threshold value.

Items and/or techniques described herein may provide one or more of the following capabilities, as well as other capabilities not mentioned. Wireless devices may be configured to exchange positioning signals to determine a range between the devices (e.g., based on time-of-flight measurements) and a bearing to one another (e.g., based on angle-of-arrival measurements). Reverse positioning of access points may utilize short range communications from other wireless devices in a network. The location of an access point may be adapted based on the quality of position estimates for the other wireless devices and the quality of the measurement technology used to obtain positioning measurements. Crowdsourcing techniques may be used to fuse positioning measurements obtained by wireless devices with position estimates obtained by an access point. The locations of access points and wireless devices may be obtained jointly to reduce the impact of synchronization errors and group delays associated with positioning reference signals. In an enterprise environment, access points may be configured to exchange positioning measurements to determine the location of access points in the network. The location estimates of the access points may be adapted based on quality metrics associated with the positioning measurements. Other capabilities may be provided and not every implementation according to the disclosure must provide any, let alone all, of the capabilities discussed.

### BRIEF DESCRIPTION OF THE DRAWINGS

FIG. 1 is a block diagram of an example wireless local area network (WLAN).

FIG. 2 is a block diagram of components of an example wireless device or user equipment.

FIG. 3A is a block diagram of components of an example access point.

FIG. 3B is a block diagram of components of an example ultrawideband (UWB) device.

FIG. 4 is a block diagram of an example communications module with multiple transceivers.

FIGS. 5A and 5B include example message flow diagrams used for Enhanced Ranging Devices (ERDEVs).

FIG. 6A is a diagram of example signal exchanges for UWB ranging.

FIG. 6B is a diagram of an example angle of arrival of a UWB signal.

FIG. 7 is a message flow diagram of an example ranging session in WiFi.

FIG. 8 is an example wireless communication system.

FIG. 9A is an example use case for reverse positioning with multiple measurement technologies.

FIG. 9B is an example data structure with a plurality of measurement technologies and example quality values.

FIG. 10 is an example message flow diagram for jointly computing access point and user equipment positions.

FIG. 11A is an example of inter-access point positioning measurements in a wireless network.

FIG. 11B is an example message flow for computing position estimates using inter-access point measurements in a wireless network.

FIG. 12 is a block diagram of components of a server.

FIG. 13 is a process flow diagram of an example method for determining the location of an access point.

FIG. 14 is a process flow diagram of an example method for prioritizing positioning measurements.

### DETAILED DESCRIPTION

Techniques are discussed herein for positioning wireless devices such as access points and other wireless nodes. Wireless devices may be configured to determine a range between the devices based on exchanging radio frequency (RF) signals. Cellular, WiFi, Bluetooth®), Bluetooth® Low Energy (BLE), sidelink. ultrawideband (UWB), and other wireless technologies may utilize ranging signals such as positioning reference signals (PRS), fine timing messages (FTM), and other time-scheduled or contention-free techniques to determine the relative distance between stations. For example, wireless positioning technologies may be utilized to provide accurate relative positioning between devices within a limited range. Two wireless devices may be configured to exchange RF signals to determine time-of-flight (ToF) and angle-of-arrival (AoA) information for the RF signals. Stations, such as Access Points (APs) which are configured to support short range wireless technologies (e.g., WiFi, UWB. BLE, etc.) are typically installed to provide wireless services and may not be associated with a known position. The techniques provided herein may utilize multiple RF technologies to measure ranges between wireless devices and determine the locations of APs in a network. Once the locations of the APs in a network are known, the APs may be configured to provide location services to other wireless devices in the network. The benefit of this approach may be particularly useful in indoor settings (e.g., where Global Navigation Satellite Systems (GNSS) or cellular may not perform as well).

Prior AP reverse positioning techniques may utilize the centroid of the AP's coverage area (as detected and reported by other wireless devices) to estimate the position of the AP. The approach, however, is prone to errors since the positions of reporting wireless devices may be associated with position errors. Further, weak transmissions from distant wireless devices may distort the boundary of the coverage area, which may impact the estimate of the AP position.

The techniques provided herein provide alternative strategies and associated message flows for improving reverse positioning performance. In an example, reporting wireless devices (e.g., UEs and other stations) and the associated positioning measurements may be prioritized. Some APs may be equipped with cellular or GNSS radios and may be configured to augment a crowdsourcing-based reverse positioning approach. In an example, AP and UEs may be configured to jointly estimate their positions based on RF signal exchanges. In a network with multiple APs (e.g., an enterprise infrastructure), the APs may be configured to perform measurement exchanges with one another to establish their locations. In an example, a location server or an AP may be configured to select positioning measurements based on the certainty of a position estimate of the station transmitting or receiving the positioning signal. Other factors such as measurement uncertainty, quality of measurement, capabilities of the stations, and geometry of the stations (e.g., dilution of precision) may be used to select positioning measurements to improve the reverse positioning performance. In an example, crowdsourced measurements may be used to establish a coarse position of an AP and a server (or AP) may be configured to select other positioning measurements (e.g., higher quality measurements) to refine the position estimate for the AP. The additional position estimates may utilize different technologies (e.g., GNSS, WiFi, NR, UWB, BLE, etc.). Measurements from multiple radio access technologies (RATs) may be used to position the AP. In an example, visual positioning may be used to assist with tuning the RAT measurements. These techniques and configurations are examples, and other techniques and configurations may be used.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

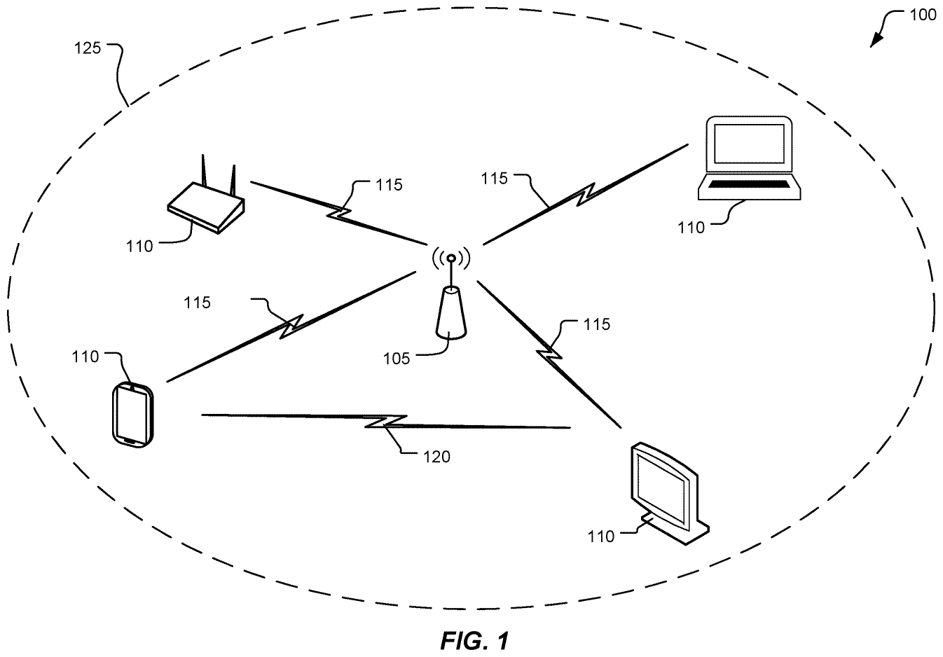

Referring to FIG. 1, a block diagram illustrates an example of a WLAN network 100 such as, e.g., a network implementing IEEE 802.11 and IEEE 802.15 families of standards. The WLAN network 100 may include an access point (AP) 105 and one or more wireless devices 110 or stations (STAs) 110, such as mobile stations, head mounted devices (HMDs), personal digital assistants (PDAs), asset tracking devices, other handheld devices, netbooks, notebook computers, tablet computers, laptops, display devices (e.g., TVs, computer monitors, etc.), printers, IoT devices, asset tags, key fobs, vehicles, etc. The AP 105 and the wireless devices 110 may be WiFi, Bluetooth®, and/or UWB capable devices. While one AP 105 is illustrated, the WLAN network 100 may have multiple APs 105. Each of the wireless devices 110, which may also be referred to as mobile stations (MSs), mobile devices, access terminals (ATs), user equipment(s) (UE), wireless nodes, wireless devices, subscriber stations (SSs), or subscriber units, may associate and communicate with an AP 105 via a communication link 115. Each AP 105 has a geographic coverage area 125 such that wireless devices 110 within that area can typically communicate with the AP 105. The wireless devices 110 may be dispersed throughout the geographic coverage area 125. Each wireless device 110 may be stationary or mobile.

A wireless device 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) is used to connect APs 105 in an extended service set. A geographic coverage area 125 for an access point 105 may be divided into sectors making up a portion of the coverage area.

The WLAN network 100 may include access points 105 of different types (e.g., metropolitan area, home network, etc.), with varying sizes of coverage areas and overlapping coverage areas for different technologies. In other examples, other wireless devices can communicate with the AP 105.

While the wireless devices 110 may communicate with each other through the AP 105 using communication links 115, each wireless device 110 may also communicate directly with one or more other wireless devices 110 via a direct wireless link 120. Two or more wireless devices 110 may communicate via a direct wireless link 120 when both wireless devices 110 are in the AP geographic coverage area 125 or when one or neither wireless device 110 is within the AP geographic coverage area 125.

Examples of direct wireless links 120 may include WiFi Direct connections, connections established by using a WiFi Tunneled Direct Link Setup (TDLS) link, 5G-NR sidelink, PC5, UWB, Bluetooth®, and other P2P group connections. The wireless devices 110 in these examples may communicate according to the WLAN radio and baseband protocol including physical and MAC layers from IEEE 802.11 and IEEE 802.15, and their various versions. For example, the one or more of the wireless devices 110 and the AP 105 may be configured to utilize WiFi, Bluetooth®, and/or UWB signals for communications and/or positioning applications.

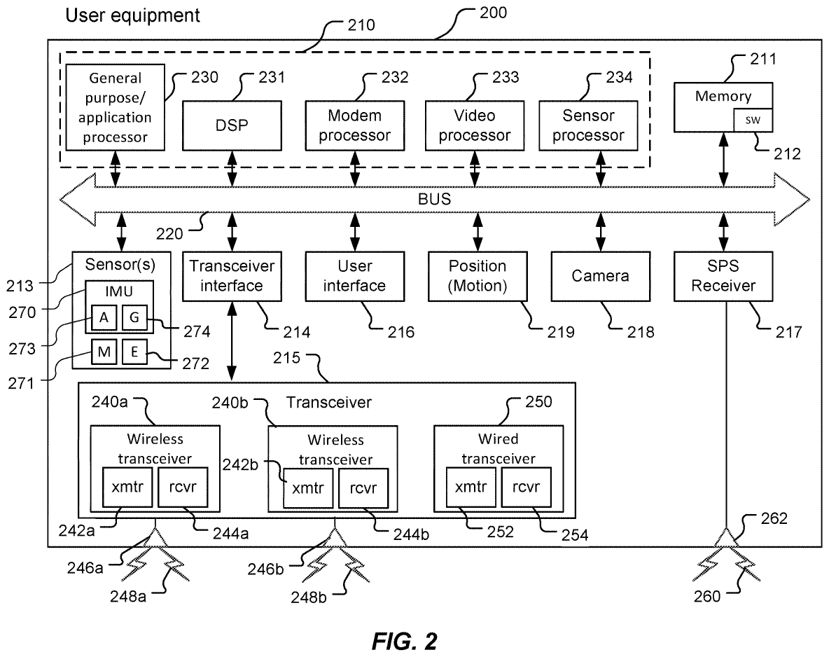

Referring also to FIG. 2, a UE 200 is an example of the wireless devices 110 and comprises a computing platform including a processor 210, memory 211 including software (SW) 212, one or more sensors 213, a transceiver interface 214 for a transceiver 215 (including one or more wireless transceivers such as a first wireless transceiver 240a, a second wireless transceiver 240b, and optionally a wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatuses (e.g., the camera 218, the position (motion) device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radio frequency (RF) sensing and ultrasound. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software (which may also include firmware) 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceivers 240a-b.

Other example configurations include one or more of the processors 230-234 of the processor 210, the memory 211, the wireless transceivers 240a-b, and one or more of the sensor(s) 213, the user interface 216, the SPS receiver 217, the camera 218, the PMD 219, and/or the wired transceiver 250. Other configurations may not include all of the components of the UE 200. For example, an IoT device may include more wireless transceivers 240a-b, the memory 211 and a general-purpose processor 230. A multi-link device may simultaneously utilize the first wireless transceiver 240a on a first link using a first frequency band, and the second wireless transceiver 240b on a second link using a second frequency band. Additional transceivers may also be used for additional links and frequency bands and radio access technologies.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile. In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions.

Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include wireless transceivers 240a-b and a wired transceiver 250 configured to communicate with other devices through wireless connections and wired connections, respectively. In an example, each of the wireless transceivers 240a-b may include respective transmitters 242a-b and receivers 244a-b coupled to one or more respective antennas 246a-b for transmitting and/or receiving wireless signals 248a-b and transducing signals from the wireless signals 248a-b to wired (e.g., electrical and/or optical) signals and from wired (e.g., electrical and/or optical) signals to the wireless signals 248a-b. Thus, the transmitters 242a-b may be the same transmitter, or may include multiple transmitters that may be discrete components or combined/integrated components, and/or the receivers 244a-b may be the same receiver, or may include multiple receivers that may be discrete components or combined/integrated components. The wireless transceivers 240a-b may be configured to communicate signals (e.g., with access points and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11ax and 802.11be), WiFi, WiFi Direct (WiFi-D), Bluetooth®, IEEE 802.15 (UWB), Zigbee etc. The wired transceiver 250 may include a transmitter 252 and a receiver 254 configured for wired communication. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user.

Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216. In an example, the user interface 216 may include one or more biometric sensors configured to obtain biometric information from a user. For example, the biometric sensors may include a fingerprint capture device, a microphone (for voice input), the camera 218 (e.g., for facial recognition, iris detection), a display (e.g., for finger swipe recognition) or other such sensors. The IMU 270 may be configured to obtain motion data to determine biometric information such as the user's gait or step length. Other sensors in the UE 200 may also be used to obtain biometric information from a user.

The SPS receiver 217 (e.g., a Global Positioning System (GPS) receiver) may be capable of receiving and acquiring SPS signals 260 via an SPS antenna 262. The antenna 262 is configured to transduce the SPS signals 260 to wired signals, e.g., electrical or optical signals, and may be integrated with one or more of the antennas 246a-b. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceivers 240a-b) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery.

The camera 218 may comprise, for example, an imaging sensor (e.g., a charge coupled device or a CMOS imager), a lens, analog-to-digital circuitry, frame buffers, etc.

Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the wireless signals 248a-b) for trilateration or multilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200.

The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion. In an example the PMD 219 may be referred to as a Positioning Engine (PE), and may be performed by the general-purpose processor 230. For example, the PMD 219 may be a logical entity and may be integrated with the general-purpose processor 230 and the memory 211.

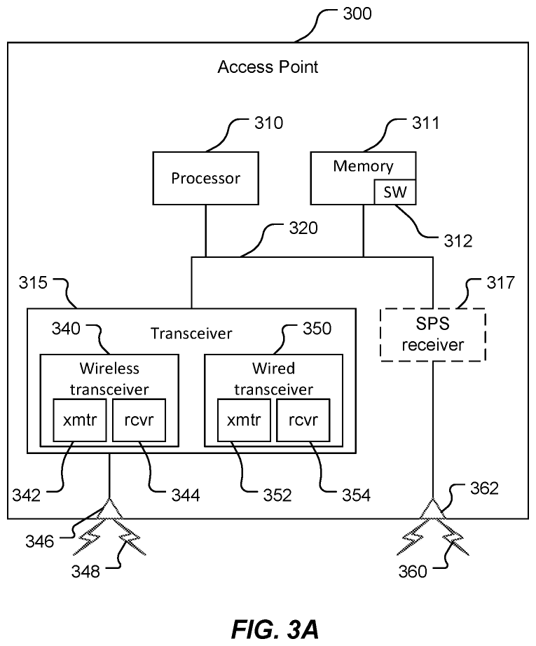

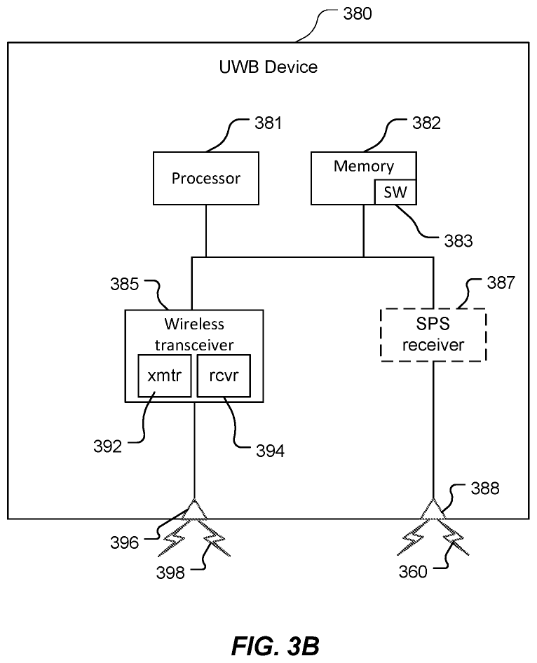

Referring also to FIG. 3A, an example of an access point (AP) 300 such as the AP 105 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatuses (e.g., a wireless interface and/or the SPS receiver 317) may be omitted from the AP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The processor 310 may include a memory with stored instructions in addition to and/or instead of the memory 311.

Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels) and/or receiving (e.g., on one or more downlink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs. and/or one or more other devices) according to a variety of radio access technologies (RATs) such as IEEE 802.11 (including IEEE 802.11ax and 802.11be), WiFi, WiFi Direct (WiFi-D), Bluetooth®, IEEE 802.15 (UWB), Zigbee etc. The wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

Referring also to FIG. 3B, an example of an UWB device 380 such as an asset tag, key fob, TV remote, security system (e.g., vehicle, commercial, etc.), or other device configured to send and receive UWB RF transmissions. The UWB device comprises a computing platform including a processor 381, memory 382 including software (SW) 383, a wireless transceiver 385, and (optionally) an SPS receiver 387. The SPS receiver 387 may be configured similarly to the SPS receiver 217 to be capable of receiving and acquiring SPS signals 360 via an SPS antenna 388. The processor 381 may include one or more intelligent hardware devices, e.g., a central processing unit (CPU), a microcontroller, an application specific integrated circuit (ASIC), etc. The processor 381 may comprise multiple processors (e.g., including a general-purpose/application processor, a DSP, a modem processor, a video processor, and/or a sensor processor as shown in FIG. 2). The memory 382 is a non-transitory storage medium that may include random access memory (RAM)), flash memory, disc memory, and/or read-only memory (ROM), etc. The memory 382 stores the software 383 which may be processor-readable, processor-executable software code containing instructions that are configured to, when executed, cause the processor 381 to perform various functions described herein. Alternatively, the software 383 may not be directly executable by the processor 381 but may be configured to cause the processor 381, e.g., when compiled and executed, to perform the functions. The description may refer to the processor 381 performing a function, but this includes other implementations such as where the processor 381 executes software and/or firmware. The description may refer to the processor 381 performing a function as shorthand for one or more of the processors contained in the processor 381 performing the function. The processor 381 may include a memory with stored instructions in addition to and/or instead of the memory 382.

Functionality of the processor 381 is discussed more fully below.

The wireless transceiver 385 is configured to communicate with other devices through wireless connections using UWB protocols. For example, the wireless transceiver 385 may include a transmitter 392 and receiver 394 coupled to one or more antennas 396 for transmitting (e.g., on one or more uplink channels) and/or receiving (e.g., on one or more downlink channels) UWB wireless signals 398 and transducing signals from the UWB wireless signals 398 to wired (e.g., electrical and/or optical) signals and from wired (e.g., electrical and/or optical) signals to the UWB wireless signals 398. In an example, the wireless transceiver 385 may include multiple transmitters that may be discrete components or combined/integrated components, and/or the receiver 394 may include multiple receivers that may be discrete components or combined/integrated components. In an example, the wireless transceiver 385 may be configured to communicate signals according to a variety of radio access technologies (RATs) in addition to UWB technologies. For example, the wireless transceiver 385 may be also configured to utilize RATs such as IEEE 802.11 (including IEEE 802.11ax/az and 802.11be), WiFi, WiFi Direct (WiFi-D), Bluetooth®, IEEE 802.15 (UWB), Zigbee etc.

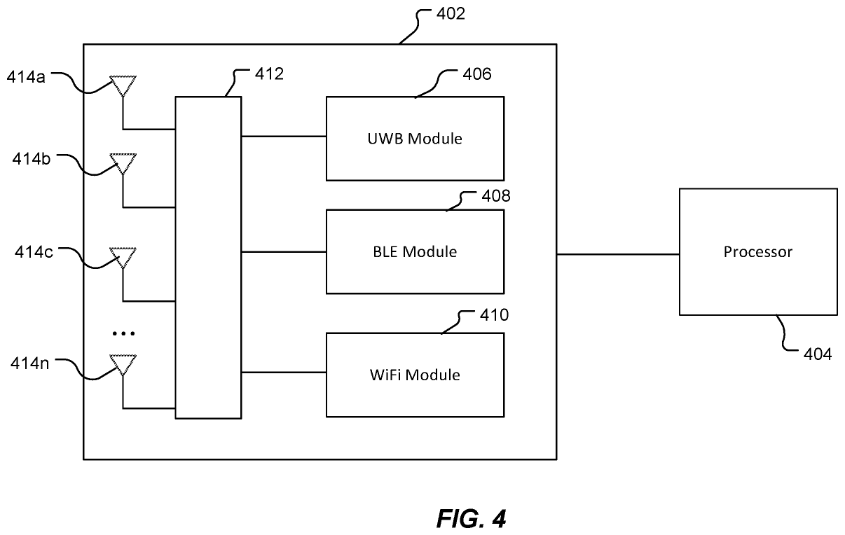

Referring to FIG. 4, a block diagram of an example communications module 402 with multiple transceivers is shown. The communications module 402 may be used as a transceiver in a mobile device, such as the transceiver 215 in the UE 200, a transceiver in an access point, such as the transceiver 315 in the AP 300, or other RF device, such as the transceiver 385 in the UWB device 380. In an example, in a V2X network, the communication module may be included in a Roadside Unit (RSU). The communications module 402 may be communicatively coupled to a processor 404, such as the general-purpose processor 230 and/or the modem processor 232. One or more RF modules such as a UWB module 406, a BLE module 408, and a WiFi module 410 may be communicatively coupled to a plurality of antennas 414a-n via one or more multiplexers 412. The multiplexers 412 may include switches, phase shifters, and tuning circuits configured to enable one or more of the RF modules 406, 408, 410 to send and receive signals via one or more of the antennas 414a-n. For example, the WiFi module 410 and the UWB module 406 may be configured to utilize one or more of the antennas 414a-n based on operational frequencies. The phase shifters, and other components within the multiplexers 412 (e.g., a Butler matrix), may enable beamforming to increase transmit or receive gain on different boresight angles from the location of the antennas 414a-n.

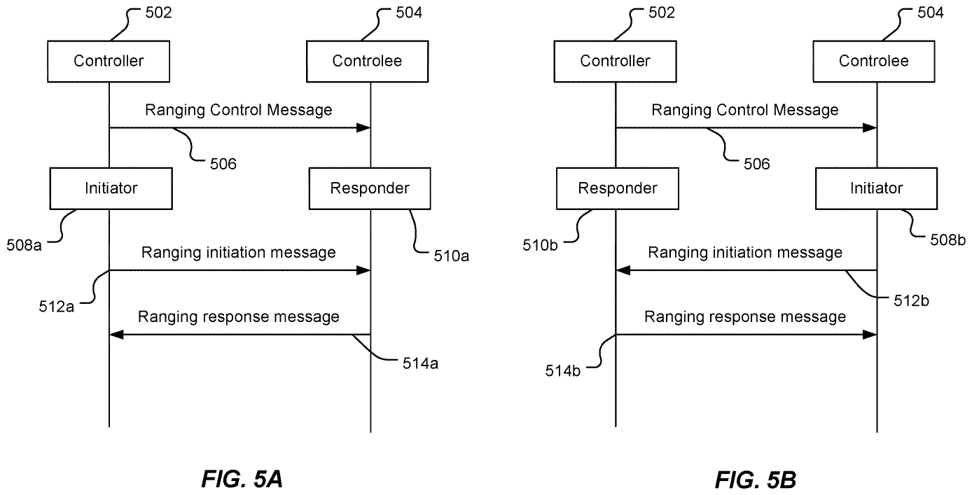

Referring to FIGS. 5A and 5B, example message flow diagrams used for Enhanced Ranging Devices (ERDEVs) are shown. Two devices such as the UE 200 and a UWB device 380 may be configured to exchange messages to determine a range (e.g., distance) between one another. As the controller 502, the UE 200 may establish the parameters for a UWB ranging session and provide the session information to the controlee 504 via one or more Ranging Control Messages (RCMs) 506. The RCM 506 may include ranging parameters, such as channel information, ranging block and slot configurations, to enable the stations to perform a time-scheduled or contention-free UWB ranging session. The controlee 504 may be configured to utilize the ranging parameters received from the controller 502 in the RCM 506. In an example, the controller 502 and the controlee 504 may exchange RCMs 506 to negotiate the session parameters. The concepts of the controller 502 and the controlee 504 are based on an upper layer networking perspective, and roles of an initiator and responder may be used on the physical and medium access control (MAC) layers. Utilizing the ranging parameters included in the RCM 506, an initiator 508a, 508b is configured to initiate a ranging exchange by sending the first message of the exchange, such as a ranging initiation message (RIM) 512a, 512b. As depicted in FIGS. 5A and 5B, either the controller 502 or the controlee 504 may assume the respective roles as the initiator 508a. 508b. Similarly, the controller 502 and the controlee 504 may be configured as the respective responder 510a, 510b and may respond to the respective RIMs 512a, 512b with ranging response messages (RRMs) 514a, 514b. In general, UWB ranging is designed to have a relatively low complexity data structure to enable ranging between relatively low cost devices (e.g., low complexity devices). The ranging sessions may be time division multiple access (TDMA) based with ranging blocks being the primary unit.

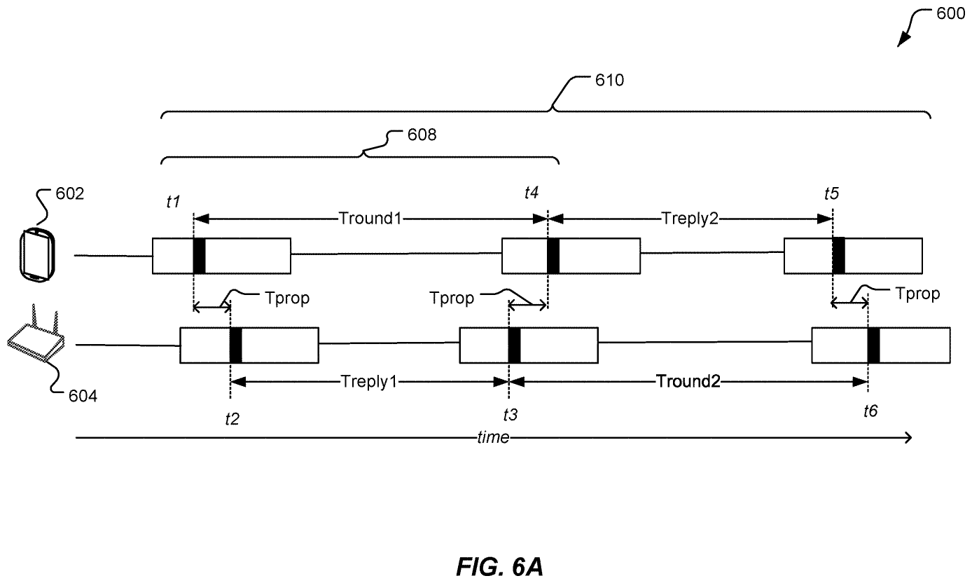

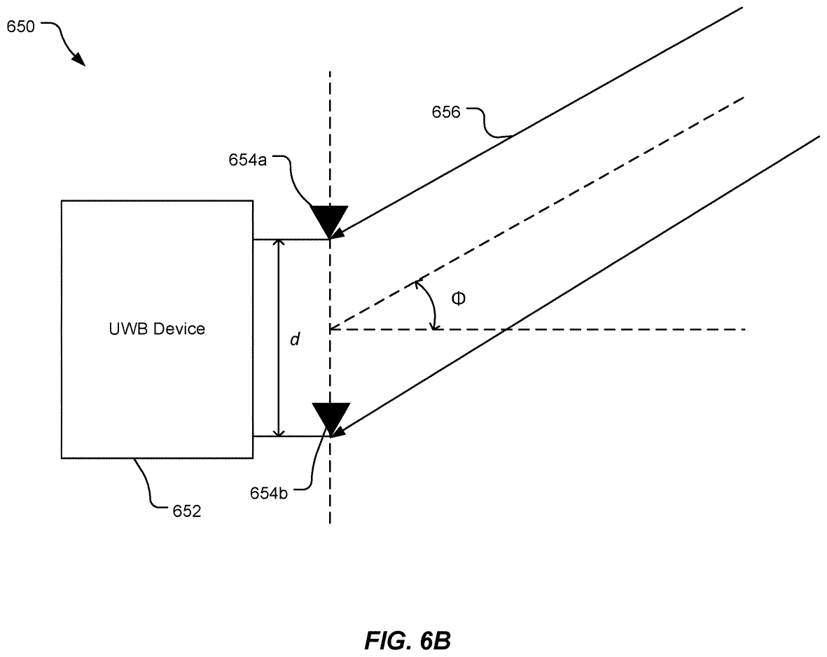

Referring to FIG. 6A, a diagram 600 of example signal exchanges for UWB ranging is shown. The diagram 600 includes a first UWB device 602 (e.g., a smartphone) and a second UWB device 604 (e.g., an AP or other wireless device). The UWB devices 602, 604 may include some or all of the components of the UE 200, the AP 300, and/or the UWB device 380. The UE 200 is an example of the first UWB device 602, and the AP 300 is an example of the second UWB device 604. Each of the UWB devices 602, 604 includes one or more transceivers configured to send and receive UWB signals, such as depicted in the communications module 402. The signal exchanges may be based in the IEEE 802.15.4 standard and may utilize the physical layer (PHY) and media access control (MAC) sublayers to enable secure ranging. The positioning exchanges may also utilize IEEE 802.15.4z security features such as STS in the UWB ranging frame to prevent preamble insertion attacks. In a first example, the UWB signals comprise a single-sided two-way ranging exchange 608 such that the first UWB device 602 transmits a ranging marker at time t1 which is received by the second UWB device 604 at time t2. The second UWB device 604 may send an acknowledgement frame at time t3, which is received by the first UWB device at time t4. A first round time (Tround1) is equal to t4-t1, and a first reply time (Treply1) is equal to t3-t1. The second UWB device 604 may be configured to provide the Treply1 time to the first UWB device 602. The first UWB device 602 may compute a first round trip propagation time:

$$Tprop 1 = Tround 1 - Treply 1 \qquad ( 1 )$$

The distance between the first UWB device 602 and the second UWB device 604 is equal to:

$$distance = c * ( Tprop 1 / 2 ) \qquad ( 2 )$$

where c=the speed of light.

In a second example, the signals comprise a double-sided two-way ranging exchange 610 such that the first UWB device 602 will also transmit an acknowledgment at time t5 which is received by the second UWB device 604 at time t6. The first UWB device 602 may provide a second reply time (Treply2) (i.e., t5-t4) to the second UWB device 604. The Tprop time may be computed as:

$$Tprop = ( ( Tround 1 * Tround 2 ) - ( Treply 1 * Treply 2 ) ) \text{} / ( Tround 1 + Tround 2 - Treply 1 - Treply 2 ) \qquad ( 3 )$$

The propagation times (i.e., Tprop) represent the time-of-flight (ToF) of the respective signals between the UWB devices 602, 604 and may be used to determine the distance between the UWB devices 602, 604. In operation, a UWB device may be configured to determine distances up to 100 m with an accuracy of approximately +/−10 cm.

Referring to FIG. 6B, a diagram 650 of an example angle of arrival of a UWB signal is shown. The diagram 650 includes a UWB device 652 (e.g., the first UWB device 602 or the second UWB device 604) with a plurality of antennas 654a, 654b in an antenna array. A UWB signal 656 is detected at an angle of arrival (AoA) (P by the antenna array. In general, the AoA is based on a time difference between the arrival of the UWB signal 656 at each of the antennas 654a, 654b in the antenna array. The time delay between the arrival of the signals may be determined as:

$$t = d * sin Φ / c \qquad ( 4 )$$

where,
t is the time delay:
d is the distance between the antennas:
   φ is the AoA; and
c is the speed of light.

In operation, the UWB device may be configured to determine an AoA with an accuracy of approximately of +/−1.5 degrees. Other radio technologies and transceiver/antenna configurations may realize different accuracy results.

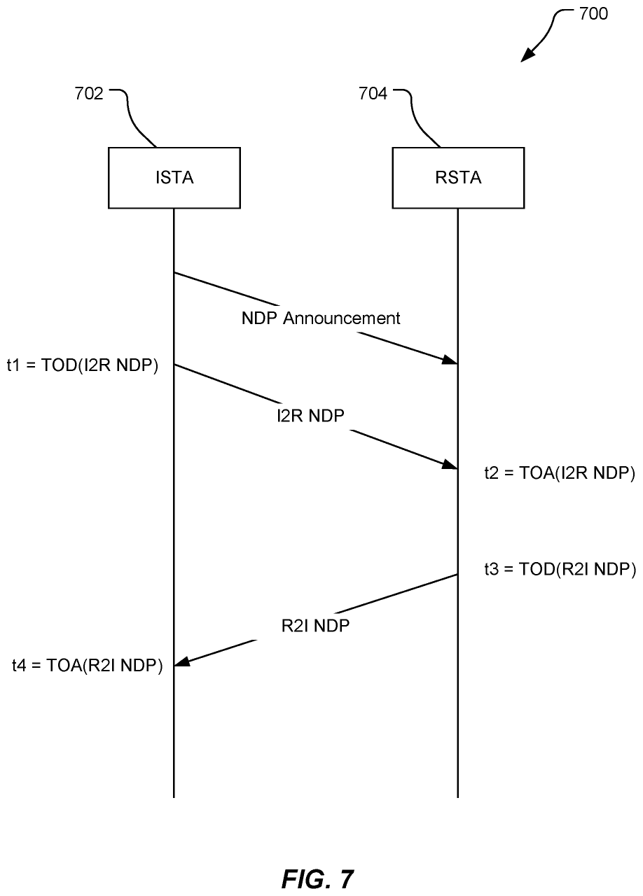

Referring to FIG. 7, a message flow diagram 700 of an example ranging session in WiFi is shown. The diagram 700 includes an initiating station 702 and a responding station 704 configured to exchange ranging messages. Each of the stations 702, 704 may include some or all of the components of the UE 200 and the AP 300, and the UE 200 and the AP 300 are examples of either one or both of the stations 702, 704. In a use case, the initiating station 702 is a UE, key fob, IOT device, etc., and the responding station 704 is an AP 300. The signal exchange in the diagram 700 may comply with industry standards such as IEEE 802.1 lax/az. In a non-trigger based ranging session, the stations may initiate the session using carrier-sense multiple access with collision avoidance (CSMA/CA). The stations 702, 704 may send and receive ranging frames such as null data packets (NDP) including a preamble and physical layer information (e.g., headers, payloads). After a NDP announcement frame is transmitted successfully, the stations may transmit subsequent NDPs within the shortest interframe spacing (SIFS) to retain the channel. In an example, the biometric information and other secure sequences described herein may be included in the physical layer payloads.

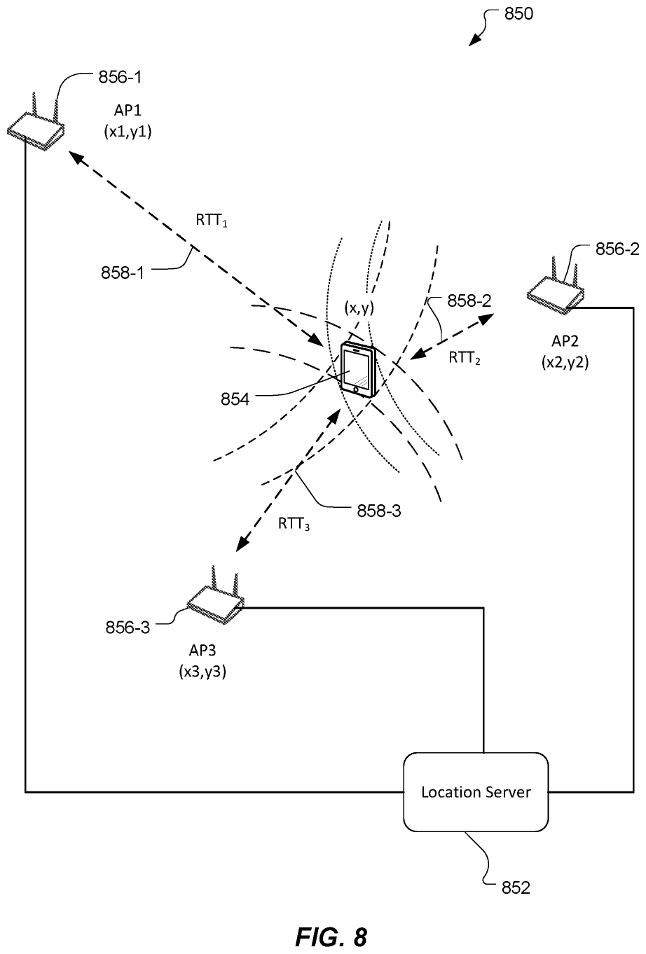

Referring to FIG. 8, an example wireless communications network 850 according to aspects of the disclosure is shown. A location server 852 may be configured to calculate a position estimate for a wireless device, such as a UE 854, or assist another entity (e.g., an AP, the UE 854, another UE, a location server, a third party application, etc.) to calculate a position estimate of the UE 854. The UE 854 may communicate wirelessly with a plurality of access points 856-1, 856-2, and 856-3 (which may correspond to the AP 300 and/or UWB device 380 described herein) using RF signals and standardized protocols for the modulation of the RF signals and the exchange of information packets. By extracting different types of information from the exchanged RF signals, and utilizing the layout of the wireless network 850 (i.e., the AP's locations, geometry, etc.), the location server 852 may determine a position of the UE 854, or assist in the determination of the position, in a predefined reference coordinate system. In an aspect, the location server 852 may specify the position using a two-dimensional coordinate system; however, the aspects disclosed herein are not so limited, and may also be applicable to determining positions using a three-dimensional coordinate system, if the extra dimension is desired. Additionally, while FIG. 8 illustrates one UE 854 and three AP 856-1, 856-2, 856-3, as will be appreciated, there may be more UEs 854 and more base stations.

In an example, to support position estimates, the APs 856-1, 856-2, 856-3 may be configured to broadcast reference RF signals to UEs in their coverage area to enable a UE 854 to measure characteristics of such reference RF signals. For example, the UE 854 may measure the Time of Arrival (ToA) and/or Reference Signal Strength Indicator (RSSI) of specific reference RF signals transmitted by at least three different APs and may use the RTT positioning method to report these ToAs (and additional information) back to the location server 852 (e.g., via a serving AP). In order to determine the position (x, y) of the UE 854, the entity determining the position of the UE 854 needs to know the locations of the APs 856-1, 856-2, 856-3, which may be represented in a reference coordinate system as (xₖ, yₖ), where k=1, 2, 3 in the example of FIG. 8.

Where one of the APs 856-2 (e.g., the serving AP) or the UE 854 determines the position of the UE 854, the locations of the involved APs 856-1, 856-3 may be provided to the serving AP 856-2 or the UE 854 by the location server 852 (which has information of the network geometry). Alternatively, the location server 852 may determine the position of the UE 854 using the known network geometry.

Either the UE 854 or the respective APs 856-1, 856-2, 856-3 may determine the distance (dₖ, where k=1, 2, 3) between the UE 854 and the respective APs 856-1, 856-2, 856-3. In an aspect, determining the RTT 858-1, 858-2, 858-3 of signals exchanged between the UE 854 and any AP 856-1, 856-2, 856-3 can be performed and converted to a distance (dₖ). RTT techniques can measure the time between sending a signaling message (e.g., reference RF signals) and receiving a response. The procedures in FIG. 7 are an example of a RTT technique. These methods may utilize calibration to remove any processing and hardware delays. In some environments, it may be assumed that the processing delays for the UE 854 and the APs 856-1, 856-2, 856-3 are the same.

Once each distance dₖ is determined, the UE 854, a AP 856-1, 856-2, 856-3, or the location server 852 can solve for the position (x, y) of the UE 854 by using a variety of known geometric techniques, such as, for example, trilateration. From FIG. 8, it can be seen that the position of the UE 854 ideally lies at the common intersection of three semicircles, each semicircle being defined by radius dₖ and center (xₖ, yₖ), where k=1, 2, 3.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE 854 from the location of a AP 856-1, 856-2, 856-3). The intersection of the two directions at or near the point (x, y) can provide another estimate of the location for the UE 854. In an example, a single distance and AoA with one of the APs may be used to determine an estimated position of the UE 854.

In the reverse positioning techniques provided herein, the location of the UE 854 may be known (e.g., via GNSS or other terrestrial positioning techniques), and the locations of one or more of the APs 856-1, 856-2, 856-3 may be unknown. The location server 852 may be configured utilize trilateration techniques described in FIG. 8 based on the locations of multiple UEs to determine the locations of the APs.

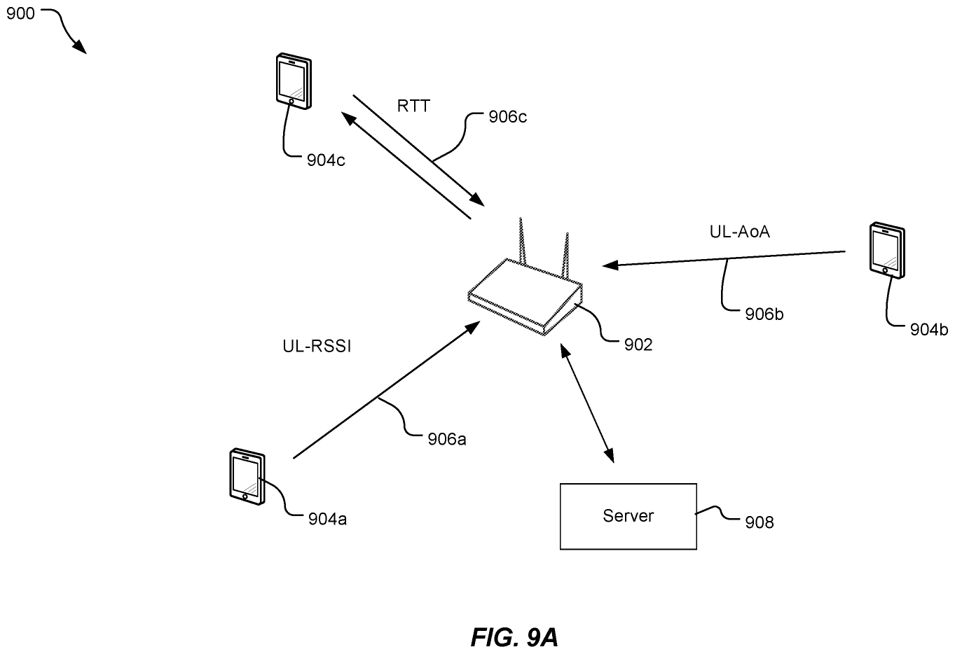

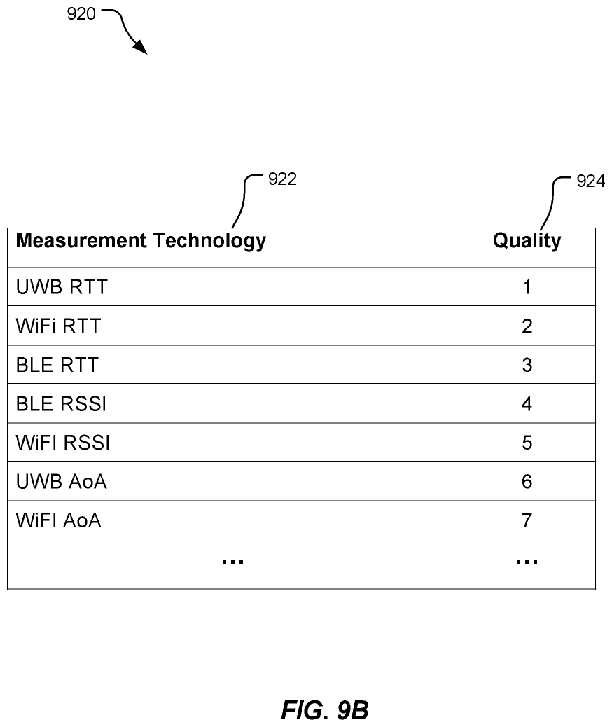

Referring to FIG. 9A, an example use case 900 for reverse positioning with multiple measurement technologies is shown. The use case 900 includes an AP 902 and a plurality of other wireless nodes such as a first UE 904a, a second UE 904b, and a third UE 904c. The UEs 904a-c may be at known locations of varying certainties, and each may be configured to provide and/or exchange measurement signals with the AP 902. For example, the first UE 904a may be configured to transmit one or more UL reference signals (RSs) 906a (e.g., SRS, SL-PRS, etc.), and the AP 902 may be configured to obtain one or more measurements based on the UL RSs 906a (e.g., RSSI, SNR). The second UE 904b may be configured to transmit one or more UL signals 906b (e.g., UWB ranging messages) and the AP 902 may be configured to obtain measurements such as the AoA of the UL signals 906b (e.g., as described in FIG. 6B). The third UE 904c may be configured to exchange ranging messages 906c (e.g., as described in FIG. 6A or 7) with the AP 902 and the UE 904c and/or the AP 902 may be configured to obtain measurements based on the ranging messages 906c.

In operation, and in contrast to prior methods which simply utilize the centroid of coverage area as the position estimate of the AP 902, the contributions from UEs 904a-c may be weighted or prioritized differently based at least in part on quality metrics associated with the positioning measurements. For example, a UE (or other wireless station) with a high certainty of its own position estimate, or a higher quality metric (e.g., as uplink RSSI or SNR at the AP) can be prioritized as compared to a UE which is less certain about its position. The AP 902, or a networked location server (e.g., a server 908), may be configured to adaptively select a subset of ‘good’ UEs to utilize for reverse positioning based on the quality metrics. The selection/grouping may be based on quality metrics such as the uncertainty in the position of the UE (e.g., as reported by the UE), the uncertainty in the measurement (e.g., as reported by the UE), and/or the uncertainty or quality of the measurement (e.g., inferred by the AP), by observing the SNR or Received Signal Strength. In an example, some measurement technologies may have a higher quality metric based on pre-established categorizations. For example, referring to FIG. 9B, an example data structure 920 including a list of measurement technologies 922 and associated quality values 924 is shown. The data structure 920 is an example, and not a limitation, as other measurement technologies and pre-established categorizations may be used. For example, the make, model and/or application executing on a UE may be associated with a quality value (e.g., a ‘premium’ UE may have superior calibration). Other factors may also be used to establish the quality of a measurement, such as the geometry of the signaling UEs or stations and the associated Dilution of Precision (DoP) effects. A subset of UEs may be selected based on quality factors and uncertainty information associated with the respective UEs position estimates. The location of the AP may be based on measurements obtained from (or with) the subset of UEs. The measurements between the AP 902 and the UEs 904a-c may be related to Time-of-Arrive (ToA) or Round Trip Time (RTT), Angle-of-Arrival (AoA), Received Signal Strength Indicator (RSSI), Round Trip Phase (RTP), and/or other RF positioning signals. The UEs 904a-c may be configured to report measurement information as part of an application-layer packet, or in the payload of the positioning reference signal.

In an example, the AP 902 may have limited computational ability and/or memory storage and may be configured to utilize different techniques to perform adaptive reverse positioning. A local computation technique may utilize local computation such that a threshold value is used to filter out measurements obtained from UEs based on the reported uncertainty value associated with a position estimate for the UE (e.g., the UE may report a position estimate and a corresponding uncertainty value). The AP 902 may be configured to selectively store the UE positions and corresponding measurements for the UEs with uncertainty values that satisfy the threshold requirements. Further, UEs with superior uncertainty values (e.g., low uncertainty) may be appended to a set and the measurements associated with UEs with a less superior uncertainty value may be discarded or ignored. The position of the AP 902 may be periodically updated based on the latest set of stored measurements.

In a remote computation technique, the AP 902 may be configured to communicate with the server 908 via wired and/or wireless connections, and the server 902 may be configured to compute the position estimate of the AP 902. For example, the AP 902 may be configured to periodically report UE position and measurement information to the server 908. The server 908 may be a private server, a Connected Intelligent Edge (CIE), or other computing device configured to perform ranging and positioning computations based on the RF measurement information obtained by the AP 902. The server 908 may provide the computed position estimate back to the AP 902.

In an example, the server 908 may provide uncertainty threshold values (and other quality parameters) to the AP 902, and the AP 902 may be configured to selectively collect and report the preferred sets of measurement information to the server 908.

In an example, the AP 902 may include cellular and/or GNSS radios and may be configured to utilize the radios to determine a position estimate. For example, the AP 902 may include the wireless transceiver 340 and/or the SPS receiver 317. The AP 902 may obtain an initial position fix (e.g., a coarse position) using cellular or GNSS, however, the AP 902 may still want to improve or fine-tune the coarse position based on crowdsourcing measurements from UEs 904a-c using short range ranging techniques as described herein (e.g., WiFi. UWB, BLE, etc.). Based on the coarse position, the AP 902 may be configured to fine-tune its crowdsourcing inputs and subsequent position estimation process. For example, a threshold or bounding area around the coarse position may be used to determine which UE logs to consider for fine-tuning. In an example, the AP 902 may be configured to utilize the bounding area as a quality metric and evaluate the positioning measurements based on an intersection with the boundary area. That is, positioning measurements which indicate the AP is outside of the boundary area may be disregarded. The AP 902 may be configured to disregard a certain UE's measurements when the uncertainty of the UEs position is greater than the uncertainty associated with the initial position fix of the AP 902 (e.g., as obtained by the AP 902 via cellular or satellite measurements). Similarly, UE logs that for the UEs with lower uncertainty may be retained. This fusion between the crowdsourced measurements and the cellular and/or satellite measurements obtained by the AP 902 may enhance the accuracy of the position estimate.

In some occasions, the initial cellular and/or satellite position fix may be erroneous, and the uncertainty that is reported by the AP 902 may also be erroneous (e.g., overconfident about an incorrect estimate). If the crowdsourced UE measurements obtained by the AP 902 point to another position estimate with higher certainty, then the AP 902 (or the server 908) may disregard the initial cellular and/or satellite position estimate. The AP 902 may be configured to place a greater weight in measurements from a diverse set of UEs that point to a different estimate, while a single cellular or satellite measurement may be overconfident about an incorrect estimate. The AP 902 may also be configured to inform the server 908 that the cellular or satellite signals have poor performance in a region that the AP 902 is located.

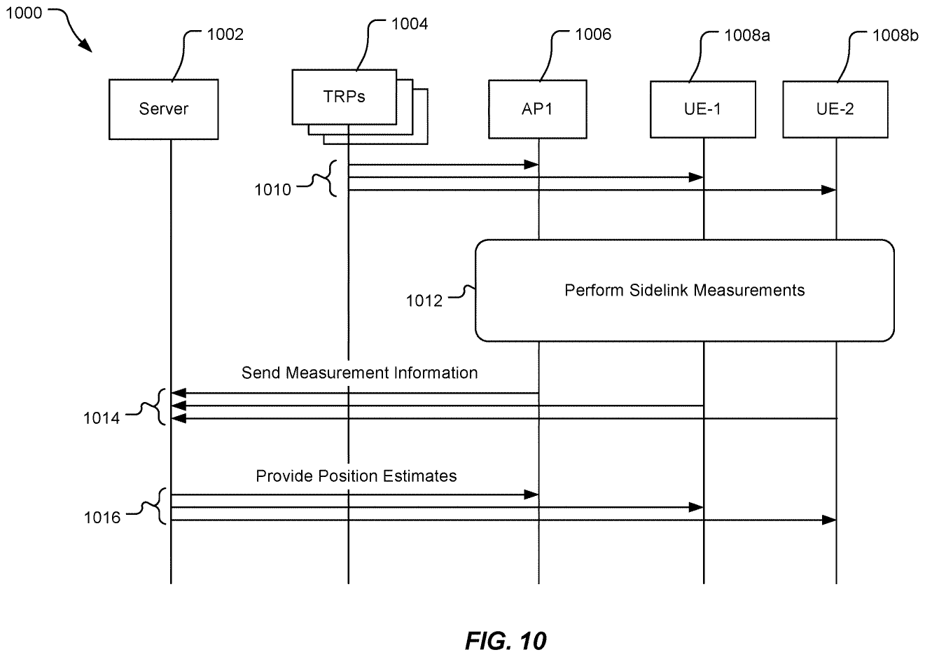

Referring to FIG. 10, an example message flow diagram 1000 for jointly computing access point and user equipment positions is shown. The message flow diagram 1000 includes a server 1002, multiple wireless nodes such as multiple Transmission Reception Points (TRPs) 1004 configured to transmit and receive positioning signals, an AP 1006, a first UE 1008a and a second UE 1008b. The number and configurations of the wireless nodes in the diagram 1000 are examples and not limitations as other network configurations with different wireless nodes may utilize the message flow. The TRPs 1004 may be configured to transmit reference signals 1010 such as positioning reference signals (PRS) which are received by the AP 1006 and the UEs 1008a, 1008b. The AP 1006 and the UEs 1008a. 1008b may be configured to perform sidelink measurements as described herein at stage 1012. For example, the AP 1006 and the UEs 1008a, 1008b may perform WiFi, UWB, BLE measurements with one another as described in FIG. 9A. The AP 1006 and the UEs 1008a, 1008b may report measurements for the reference signals 1010 and the sidelink measurements at stage 1012 to the server 1002 via measurement information messages 1014. In a 5G NR implementation, the server 1002 may be a location management function (LMF). The measurement information messages 1014 may include location information for the AP 1006 and UEs 1008a, 1008b based on cellular and/or satellite positioning techniques.

The server 1002 may be configured to compute the locations of the AP 1006 and UEs 1008a, 1008b jointly based on the measurement information messages 1014. In an example, the joint position computations may be based on double difference techniques as known in the art to reduce the impact of synchronization and group delay errors between stations. The joint computation techniques may be useful for TDoA measurements, where the effect of synchronization errors between the TRPs 1004 and group delay calibration errors in the target devices (e.g., the AP 1006 and UEs 1008a, 1008b) may be corrected. Over time, the server 1002 may be configured to adaptively select and maintain a subset of quality UEs such as described in FIG. 9A. The server 1002 may be configured to provide position estimate messages 1016 back to the AP 1006 and UEs 1008a, 1008b based on the combined measurement information. In an example, the server 1002 may be configured to provide the AP 1006 with indications of the subset of quality UEs based on the joint measurements, and the AP 1006 may use the subset of quality UEs for future position estimates.

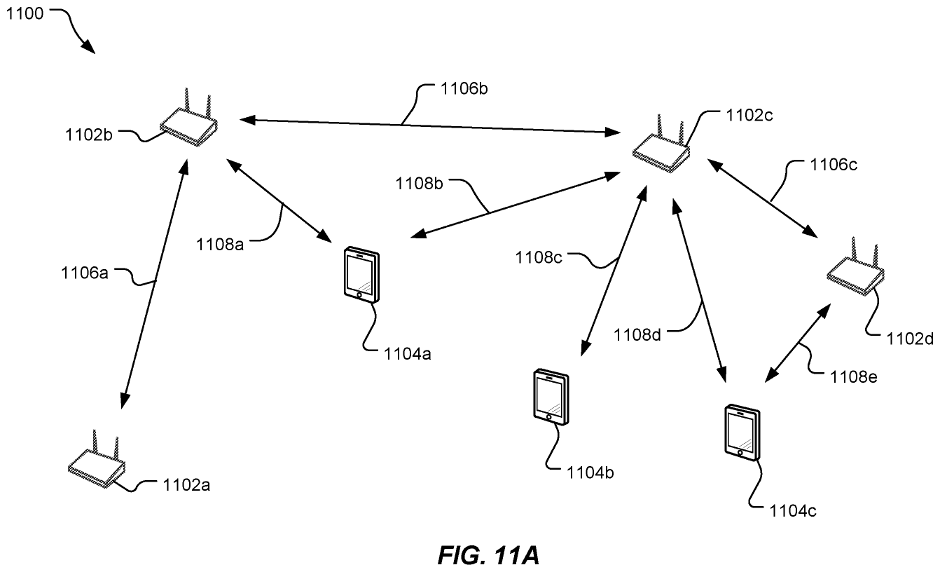

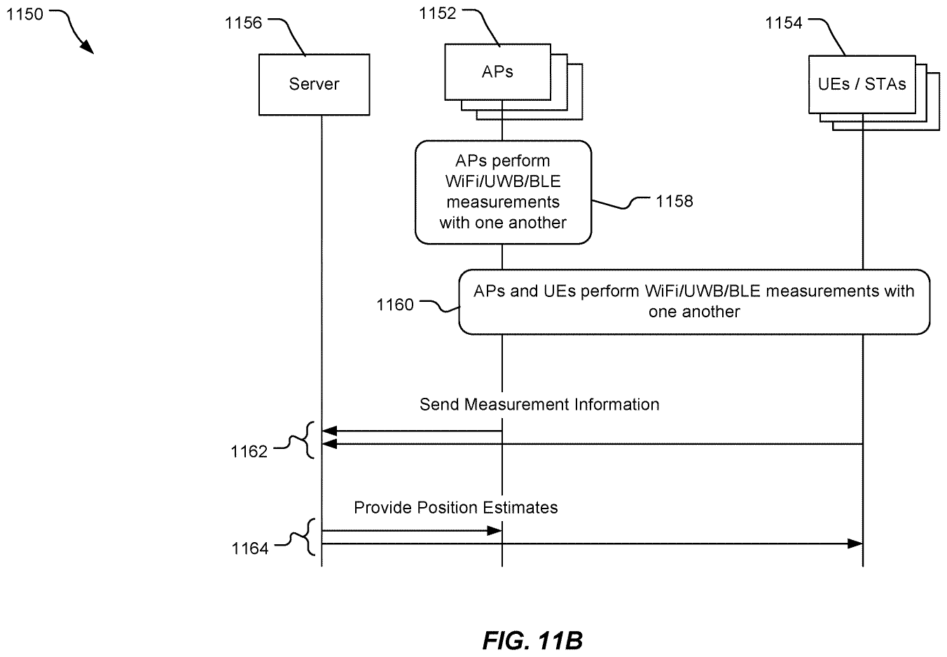

Referring to FIG. 11A, an example of inter-access point positioning measurements is a wireless network 1100 is shown. The network 1100 may be an enterprise environment where APs may be physically proximate to one another and may be configured to obtain positioning measurements based on signal exchanges between the APs. For example, a first AP 1102a may be configured to obtain measurements based on a first signal link 1106a with a second AP 1102b. The second AP 1102b may be configured to obtain measurements based on a second signal link 1106b with a third AP 1102c, which may be configured to obtain measurements based on a third signal link 1106c with a fourth AP 1102d. Multiple other wireless nodes, such as a first UE 1104a, a second UE 1104b, and a third UE 1104c may each be configured to communicate with one or more of the APs 1102a-d. For example, the first UE 1104a may be configured to communicate with the second AP 1102b with a fourth signal link 1108a, and to communicate with the third AP 1102c with a fifth signal link 1108b. The second UE 1104b may be communicating with the third AP 1102c with a sixth signal link 1108c. The third UE 1104c may be communicating with the third AP 1102c with a seventh signal link 1108d, and with the fourth AP 1102d using an eighth signal link 1108e. The numbers of stations and communication links are examples and not limitations as the location of an AP may enable communication with multiple APs.

In operation, the APs 1102a-d may utilize the inter-AP communication links (e.g., the first, second, and third signal links 1106a, 1106b, 1106c) to obtain short range RF measurements (e.g., WiFi, UWB, BLE, etc.) with one another. In an example, the APs 1102a-d may be configured to utilize UWB Fine Ranging (FiRa) messages with one another. The APs 1102a-d may also use the respective signal links with the UEs 1104a-c to obtain similar short range RF measurements (i.e., as described in FIG. 9A). A network management entity or controller (e.g., server not shown in FIG. 11A) of the network of APs 1102a-d may be configured through an upper-layer application to request the APs 1102a-d to perform measurements with each other, which are then reported back to the management entity.

In an example, referring to FIG. 11B, an example message flow diagram 1150 for computing position estimates using inter-access point measurements is a wireless network is shown. The diagram 1150 includes a server 1156 and multiple APs 1152 configured to communicate with one another. The APs 1152 may be the AP 1102a-d described in FIG. 11A. Multiple stations 1154 (e.g., UE, wireless nodes, wireless devices, etc.) may be configured to communicate with the APs 1152 and with the server 1156. At stage 1158, the APs 1152 may be configured to perform short range RF measurements (e.g., WiFi, UWB, BLE, etc.) with one another. For example, referring to FIG. 11A, the APs 1102a-d may be configured to utilize the inter-AP communication links (e.g., the first, second, and third signal links 1106a, 1106b, 1106c) to obtain the short range RF measurements.

At stage 1160, the APs 1152 and the stations 1154 may be configured to perform short range RF measurements (e.g., WiFi, UWB, BLE, etc.) as described in FIG. 9A.

The measurement information may be provided to the server 1156 via measurement information messages 1162 for analysis. As described in FIG. 9A, a subset of the APs 1152 and stations 1154 may be defined based on uncertainty and other quality metrics. The subset may be maintained by the server 1156. As examples, and not limitation, the quality metrics may be based on the quality of the UE (e.g., pre-defined make/model/application information associated with premium UEs may have superior calibration), associated with lesser uncertainty values, the geometry of the APs 1152 and the stations 1154 (e.g., DoP criteria), or combinations of these factors. This subset of APs and stations may be adaptively updated over time to further improve the position estimation performance of the APs. The inter-AP measurements obtained at stage 1158, and AP-station measurements obtained at stage 1160 may be collectively processed to generate position estimates for the APs 1152 at the server 1156. The server 1156 may be configured to provide position estimate messages 1164 to the APs 1152 and the stations 1154.

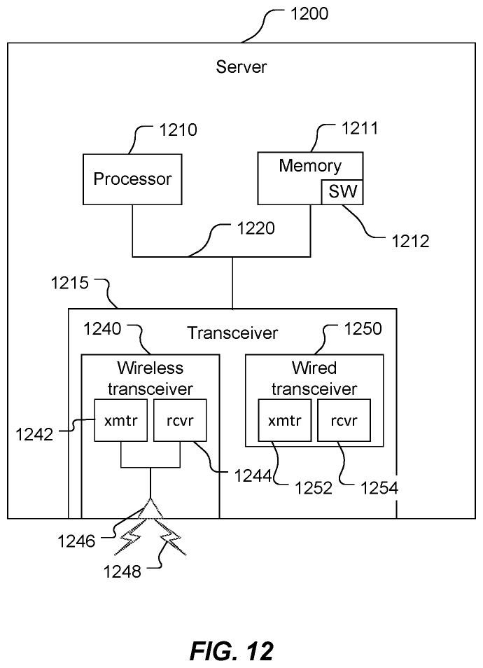

Referring also to FIG. 12, a server 1200, of which the servers 908, 1002, 1156 may be an example, may comprise a computing platform including a processor 1210, memory 1211 including software (SW) 1212, and a transceiver 1215. The processor 1210, the memory 1211, and the transceiver 1215 may be communicatively coupled to each other by a bus 1220 (which may be configured, e.g., for optical and/or electrical communication). One or more of the shown apparatus (e.g., a wireless transceiver) may be omitted from the server 1200. The processor 1210 may include one or more intelligent hardware devices, e.g., a central processing unit (CPU), a microcontroller, an application specific integrated circuit (ASIC), etc. The processor 1210 may comprise multiple processors (e.g., including a general-purpose/application processor, a DSP, a modem processor, a video processor, and/or a sensor processor). The memory 1211 may be a non-transitory storage medium that may include random access memory (RAM)), flash memory, disc memory, and/or read-only memory (ROM), etc. The memory 1211 may store the software 1212 which may be processor-readable, processor-executable software code containing instructions that are configured to, when executed, cause the processor 1210 to perform various functions described herein. Alternatively, the software 1212 may not be directly executable by the processor 1210 but may be configured to cause the processor 1210, e.g., when compiled and executed, to perform the functions. The description herein may refer to the processor 1210 performing a function, but this includes other implementations such as where the processor 1210 executes software and/or firmware. The description herein may refer to the processor 1210 performing a function as shorthand for one or more of the processors contained in the processor 1210 performing the function. The description herein may refer to the server 1200 performing a function as shorthand for one or more appropriate components of the server 1200 performing the function. The processor 1210 may include a memory with stored instructions in addition to and/or instead of the memory 1211. Functionality of the processor 1210 is discussed more fully below.

The transceiver 1215 may include a wireless transceiver 1240 and/or a wired transceiver 1250 configured to communicate with other devices through wireless connections and wired connections, respectively. For example, the wireless transceiver 1240 may include a wireless transmitter 1242 and a wireless receiver 1244 coupled to one or more antennas 1246 for transmitting (e.g., on one or more downlink channels) and/or receiving (e.g., on one or more uplink channels) wireless signals 1248 and transducing signals from the wireless signals 1248 to wired (e.g., electrical and/or optical) signals and from wired (e.g., electrical and/or optical) signals to the wireless signals 1248. Thus, the wireless transmitter 1242 may include multiple transmitters that may be discrete components or combined/integrated components, and/or the wireless receiver 1244 may include multiple receivers that may be discrete components or combined/integrated components. The wireless transceiver 1240 may be configured to communicate signals (e.g., with the APs, UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 1250 may include a wired transmitter 1252 and a wired receiver 1254 configured for wired communication with other network entities. The wired transmitter 1252 may include multiple transmitters that may be discrete components or combined/integrated components, and/or the wired receiver 1254 may include multiple receivers that may be discrete components or combined/integrated components. The wired transceiver 1250 may be configured, e.g., for optical communication and/or electrical communication.

The description herein may refer to the processor 1210 performing a function, but this includes other implementations such as where the processor 1210 executes software (stored in the memory 1211) and/or firmware. The description herein may refer to the server 1200 performing a function as shorthand for one or more appropriate components (e.g., the processor 1210 and the memory 1211) of the server 1200 performing the function. The configuration of the server 1200 shown in FIG. 12 is an example and not limiting of the disclosure, including the claims, and other configurations may be used. For example, the wireless transceiver 1240 may be omitted.

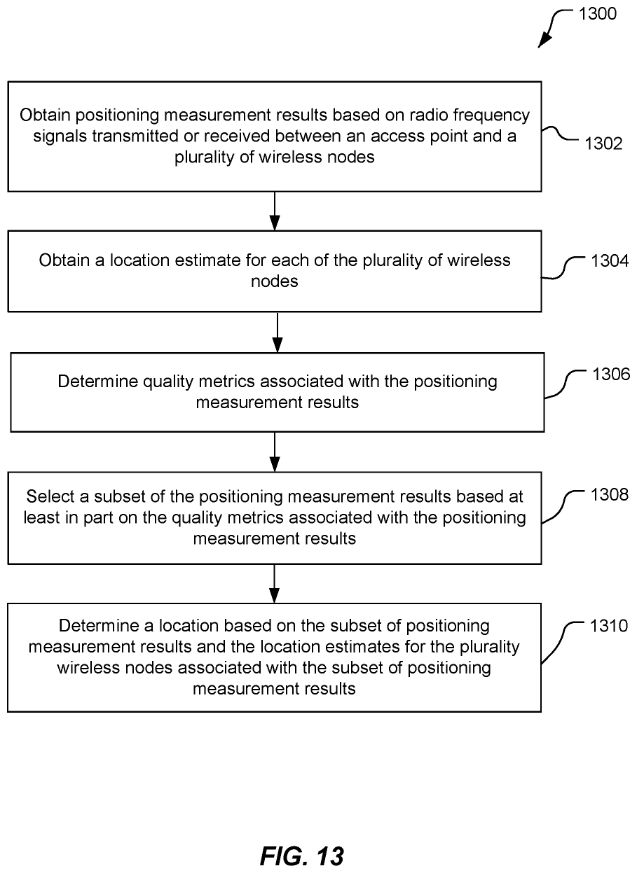

Referring to FIG. 13, with further reference to FIGS. 1-12, a method 1300 for determining a location of an access point includes the stages shown. The method 1300 is, however, an example and not limiting. The method 1300 may be altered, e.g., by having stages added, removed, rearranged, combined, performed concurrently, and/or having single stages split into multiple stages. For example, obtaining positioning measurements at stage 1302 and obtaining location estimates at stage 1304 may be performed in a single stage. The method 1300 may be performed by a AP 300 or a server 1200, or other wireless nodes configured to utilize wireless ranging procedures.

At stage 1302, the method includes obtaining positioning measurement results based on radio frequency signals transmitted or received between an access point and a plurality of wireless nodes. An AP 300, including a processor 310 and a transceiver 315, is a means for obtaining the positioning measurement results. In an example, referring to FIG. 9A, the AP 902 may be configured to obtain positioning measurements with each of the UEs 904a-c. The positioning measurement results may be based on different measurement technologies such as WiFi RTT, UWB ranging procedures, Bluetooth® RSSI, WiFi AoA, etc. For example, the first UE 904a may be configured to transmit one or more UL reference signals (RSs) 906a (e.g., SRS, SL-PRS, etc.), and the AP 902 may be configured to obtain one or more measurements based on the UL RSs 906a (e.g., RSSI, SNR). The second UE 904b may be configured to transmit one or more UL signals 906b (e.g., UWB ranging messages) and the AP 902 may be configured to obtain measurements such as the AoA of the UL signals 906b (e.g., as described in FIG. 6B). The third UE 904c may be configured to exchange ranging messages 906c (e.g., as described in FIG. 6A or 7) with the AP 902 and the UE 904c and/or the AP 902 may be configured to obtain measurements based on the ranging messages 906c. Positioning measurements may be obtained from other types of wireless nodes. For example, the wireless nodes may include other APs as described in FIG. 11A, or TRPs as described in FIG. 10. Other wireless nodes such as reference stations, IoT devices, and other beacons may be configured to send and/or receive positioning signals. In an example, the server 908 may be configured to obtain the positioning measurements from the AP 902. The AP 902 may be configured to communicate with the server 908 via wired and/or wireless connections, and the server 902 may be configured to receive the measurement information obtained by the AP 902 to perform the method 1300.

At stage 1304, the method includes obtaining a location estimate for each of the plurality of wireless nodes. The AP 300, including the processor 310 and the transceiver 315, is a means for obtaining the location estimate. In an example, referring to FIG. 9A, the UEs 904a-c may determine their respective location estimates based on signal exchanges with other stations or satellite vehicles. Terrestrial positioning techniques with a cellular network and/or position estimates based on GNSS signals may be used to determine the location estimates. The location estimates may be based on geographic coordinates (e.g., latitude, longitude, altitude) or other Cartesian or polar coordinate systems as known in the art (e.g., ENU, NED, etc.). The UEs 904a-c may be configured to provide their respective location estimates to AP 902 and/or the server 908 via application-layer packets or as part of the payload in the positioning signals exchanged with the AP 902. In an example, a networked server (e.g., 5G NR LMF) may be configured to maintain the location estimates for the UEs 904a-c, and the server 908 and/or the AP 902 may obtain the location estimates via an out-of-band communication (e.g., via an application programming interface (API) on the networked server). The location estimate may include an uncertainty value computed by the respective UE and/or network resource. The uncertainty value may be based on the quality of the corresponding terrestrial or satellite navigation fix, and the UEs 904a-c may be provide the uncertainty value as part of the location estimate.

At stage 1306, the method includes determining quality metrics associated with the positioning measurement results. The AP 300, including the processor 310 and the transceiver 315, is a means for determining the quality metrics. Referring to FIG. 9A, the contributions from UEs 904a-c may be weighted or prioritized differently based at least in part on quality metrics associated with the positioning measurement results. The quality metrics may include information such as the uncertainty in the position of the UE (e.g., as reported by the UE), the uncertainty in the measurement (e.g., as reported by the UE), and/or the uncertainty or quality of the measurement (e.g., inferred by the AP) by observing the SNR or Received Signal Strength. Some measurement technologies may have a higher quality metric based on pre-established categorizations such as described in FIG. 9B. In an example, the quality metric may be based at least in part on configuration of the UE (e.g., the make, model and/or application executing on a UE). A UE hardware configuration may have a pre-established quality metric. Other factors may also be used to determine the quality metric for a positioning measurement, such as the geometry of the signaling UEs or stations and the associated DoP effects.

At stage 1308, the method includes selecting a subset of the positioning measurement results based at least in part on the quality metrics associated with the positioning measurement results. The AP 300, including the processor 310 and the transceiver 315, is a means for selecting the subset of the positioning measurement results. In an example, referring to FIG. 9A, the AP 902 or the server 908 may be configured to adaptively select a subset of positioning measurements from the UEs 904a-c to utilize for reverse positioning based on the quality metrics determined at stage 1306. In an example, a subset of UEs may be selected based on quality factors and uncertainty information associated with the respective UEs position estimates, and the positioning measurements associated with the subset of UEs may be selected as the subset of the positioning measurements. The selection of the subset of positioning measurements may be based on a comparison of the quality metrics to one or more threshold values configured to filter out some positioning measurements. The AP 902 or the server 908 may be configured to selectively store the UE positions and corresponding positioning measurements for the UEs with quality metric values that satisfy the threshold requirements. Positioning measurements with superior quality metrics may be appended to a set and the measurements have lower quality metrics may be discarded or ignored.

At stage 1310, the method includes determining a location based on the subset of positioning measurements and the location estimates for the plurality of wireless nodes associated with the subset of positioning measurement results. The AP 300, including the processor 310 and the transceiver 315, is a means for determining the location. In an example, referring to FIG. 9A, the AP 902 or the server 908 may be configured to determine the position of the AP 902 based on the subset of positioning measurements and the locations of the UEs 904a-c. For example, trilateration techniques such as discussed in FIG. 8 may be used to determine the location. Additional measurement information, such as AoA of the positioning measurements observed by the AP 902 may be used to determine the location.

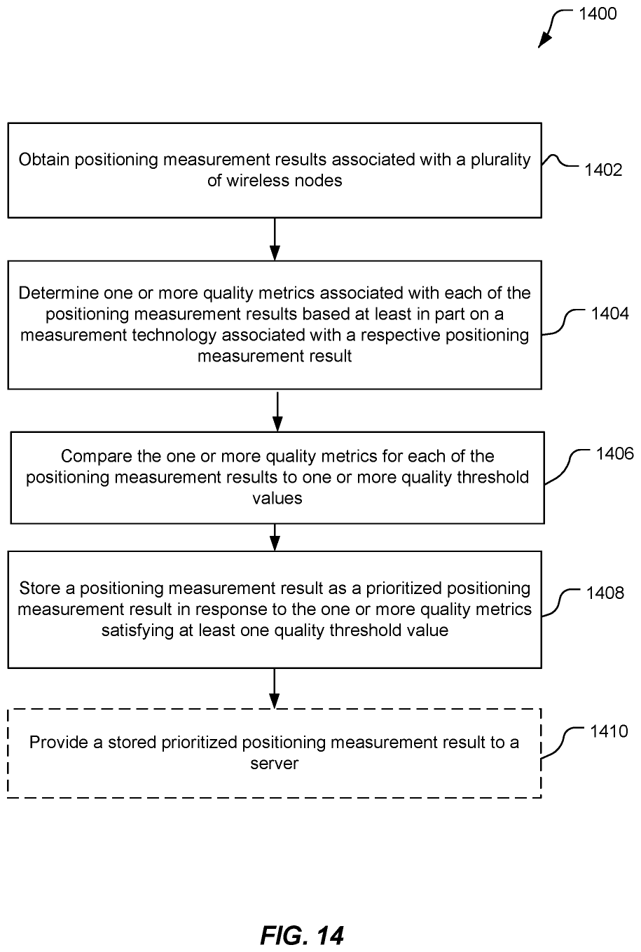

Referring to FIG. 14, with further reference to FIGS. 1-12, a method 1400 for prioritizing positioning measurements includes the stages shown. The method 1400 is, however, an example and not limiting. The method 1400 may be altered, e.g., by having stages added, removed, rearranged, combined, performed concurrently, and/or having single stages split into multiple stages. For example, providing a stored positioning measurement to a server at stage 1410 is optional. The method 1400 may be performed by a AP 300 or a server 1200, or other wireless nodes configured to utilize wireless ranging procedures.

At stage 1402, the method includes obtaining positioning measurement results associated with a plurality of wireless nodes. An AP 300, including a processor 310 and a transceiver 315, is a means for obtaining the positioning measurement results. In an example, referring to FIG. 9A, the AP 902 may be configured to exchange RF signals with each of the UEs 904-a-c to obtain the positioning measurement results. The positioning measurement results may be based on different measurement technologies such as WiFi RTT, UWB ranging procedures, Bluetooth® RSSI, WiFi AoA, etc. For example, the first UE 904a may be configured to transmit one or more UL reference signals (RSs) 906a (e.g., SRS, SL-PRS, etc.), and the AP 902 may be configured to obtain one or more measurements based on the UL RSs 906a (e.g., RSSI, SNR). The second UE 904b may be configured to transmit one or more UL signals 906b (e.g., UWB ranging messages) and the AP 902 may be configured to obtain measurements such as the AoA of the UL signals 906b (e.g., as described in FIG. 6B). The third UE 904c may be configured to exchange ranging messages 906c (e.g., as described in FIG. 6A or 7) with the AP 902 and the UE 904c and/or the AP 902 may be configured to obtain measurements based on the ranging messages 906c. Positioning measurements may be obtained from other types of wireless nodes. For example, the wireless nodes may include other APs as described in FIG. 11A, or TRPs as described in FIG. 10.

Other wireless nodes such as reference stations, IoT devices, and other beacons may be configured to send and/or receive positioning signals. In an example, the server 908 may be configured to obtain the positioning measurements from the AP 902. The AP 902 may be configured to communicate with the server 908 via wired and/or wireless connections, and the server 902 may be configured to receive the measurement information obtained by the AP 902 to perform the method 1400.

At stage 1404, the method includes determining one or more quality metrics associated with each of the positioning measurement results based at least in part on a measurement technology associated with a respective positioning measurement result.

The AP 300, including the processor 310 and the transceiver 315, is a means for determining one or more quality metrics. Referring to FIG. 9A, the contributions from UEs 904a-c may be weighted or prioritized differently based at least in part on quality metrics associated with the positioning measurements. The quality metrics may include information such as the uncertainty in the position of the UE (e.g., as reported by the UE), the uncertainty in the measurement (e.g., as reported by the UE), and/or the uncertainty or quality of the measurement (e.g., inferred by the AP) by observing the SNR or Received Signal Strength. Some measurement technologies may have a higher quality metric based on pre-established measurement technology categorizations such as described in FIG. 9B. In general, technologies which utilize a higher bandwidth for positioning measurements (e.g., UWB) will have a higher quality metric than technologies which use less bandwidth for ranging. Time based measurement technologies (e.g., RTT, ToA, etc.) may have a higher quality metric than signal strength measurement technologies (e.g., RSSI). In an example, the quality metric may be based at least in part on the make, model and/or application executing on a UE (e.g., a UE configuration may have a preestablished quality metric). Other factors may also be used to determine the quality metric for a positioning measurement, such as the geometry of the signaling UEs or stations and the associated DoP effects.

At stage 1406, the method includes comparing the one or more quality metrics for each of the positioning measurement results to one or more quality threshold values.

The AP 300, including the processor 310 and the transceiver 315, is a means for comparing the quality metrics to quality threshold values. The quality threshold values may be based on pre-configured values (e.g., a look-up table) or may be determined dynamically based on prior positioning measurements. For example, a prior positioning measurement based on a WiFi RSSI technology may establish the quality threshold value since a current position estimate may be based on that technology. Subsequent positioning measurements may be based on a different measurement technology which may have a different quality metric. Measurements based on higher quality metric (e.g., higher than WiFi RSSI) may be utilized to improve the position estimate, and measurements based on a lower quality metric may be ignored or discarded. Quality threshold values may be associated with the uncertainty associated with the location of a wireless node such that a positioning measurement may be ignored or discarded if the uncertainty value is above the quality threshold value. Quality threshold values may be associated with DoP information (e.g., the relative positions of wireless nodes), and/or the configuration and capabilities of the wireless node (e.g., positioning measurements with reduced capability UEs (RedCapUEs) may be ignored or discarded).

Combinations of quality metrics and associated threshold values may be used to accept or reject a positioning measurement. For example, a quality threshold for a measurement technology may be increased or decreased when combined with an uncertainty value of the wireless nodes position estimate. That is, a quality metric for a high quality measurement technology (e.g., UWB ranging) may be downgraded when transmitted from a wireless node with an uncertain location estimate. Quality metric values for other combinations may also be used.

At stage 1408, the method includes storing a positioning measurement result as a prioritized positioning measurement result in response to the one or more quality metrics satisfying at least one quality threshold value. The AP 300, including the processor 310 and the transceiver 315, is a means for storing the positioning measurement result. In an example, an AP 300 may be configured to selectively store the positions and corresponding measurement results for the wireless nodes which satisfy the quality value threshold requirements. The positioning measurement results with superior quality metrics may be appended to a data set (e.g., log files). The position of the AP 300 may be periodically updated based on the latest set of stored measurement results. In an example, a server 1200 may be configured to perform the method 1400 and store the range metrics in a local or networked data storage device.

At stage 1410, the method optionally includes providing a stored positioning measurement result to a server. The AP 300, including the processor 310 and the transceiver 315, is a means for providing the stored positioning measurement result to the server. In an networked environment, an AP may be configured to provide positioning measurement results to a private server, a CIE, or other computing device configured to perform ranging and positioning computations based on the positioning measurement information obtained by the AP.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. Components, functional or otherwise, shown in the figures and/or discussed herein as being connected or communicating with each other are communicatively coupled unless otherwise noted. That is, they may be directly or indirectly connected to enable communication between them.

As used herein, the singular forms “a,” “an,” and “the” include the plural forms as well, unless the context clearly indicates otherwise. For example, “a processor” may include one processor or multiple processors. The terms “comprises.” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item. e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure). Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that the device be a mobile device, but indicates that the device includes wireless communication capability (one-way or two-way). e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for determining a location of an access point, comprising: obtaining, with the access point, positioning measurement results from a plurality of wireless nodes; obtaining a location estimate for each of the plurality of wireless nodes; determining quality metrics for the positioning measurements; selecting a subset of the positioning measurements based at least in part on the quality metrics associated with the positioning measurements; and determining the location of the access point based on the subset of the positioning measurements and the location estimates for the plurality of wireless nodes associated with the subset of the positioning measurements.

Clause 2. The method of clause 1 wherein at least one of the quality metrics is an uncertainty value associated with the location estimate for at least one of the plurality of wireless nodes.

Clause 3. The method of clause 1 wherein at least one of the quality metrics is a signal-to-noise ratio value of a received positioning measurement.

Clause 4. The method of clause 1 wherein at least one of the quality metrics indicates a hardware configuration of at least one of the plurality of wireless nodes.

Clause 5. The method of clause 1 wherein selecting the subset of the positioning measurements includes comparing the quality metrics to one or more threshold values.

Clause 6. The method of clause 1 wherein at least one of the plurality of wireless nodes is an user equipment.

Clause 7. The method of clause 1 wherein at least one of the plurality of wireless nodes is an access point.

Clause 8. The method of clause 1 further comprising: obtaining a coarse location estimate for the access point; determining a bounding area around the coarse location estimate; and determining a quality metric for the positioning measurements based at least in part on an intersection with the bounding area.

Clause 9. The method of clause 1 wherein determining the location of the access point includes providing the subset of the positioning measurements to a server and receiving the location of the access point from the server.

Clause 10. The method of clause 9 further comprising: measuring one or more positioning reference signals transmitted from a transmission/reception point; and providing positioning reference signal measurement information to the server.

Clause 11. A method for prioritizing positioning measurements, comprising: obtaining positioning measurements from a plurality of wireless nodes; determining one or more quality metrics for each of the positioning measurements based at least in part on a measurement technology associated with a respective positioning measurement: comparing the one or more quality metrics for each of the positioning measurements to one or more quality threshold values; and storing a positioning measurement in response to the one or more quality metrics satisfying at least one quality threshold value.

Clause 12. The method of clause 11 further comprising providing a stored positioning measurement to a server.

Clause 13. The method of clause 11 further comprising obtaining location estimates for each of the plurality of wireless nodes, wherein at least one of the one or more quality metrics is an uncertainty value associated with a location estimate for at least one of the plurality of wireless nodes.

Clause 14. The method of clause 11 wherein at least one of the one or more quality metrics is a signal-to-noise ratio value of a positioning measurement.

Clause 15. The method of clause 11 wherein at least one of the one or more quality metrics indicates a hardware configuration of at least one of the plurality of wireless nodes.

Clause 16. The method of clause 11 wherein at least one of the plurality of wireless nodes is an user equipment.

Clause 17. The method of clause 11 wherein at least one of the plurality of wireless nodes is an access point.

Clause 18. An apparatus, comprising: at least one memory; at least one transceiver; at least one processor communicatively coupled to the at least one memory and the at least one transceiver, and configured to: obtain positioning measurements from a plurality of wireless nodes: obtain a location estimate for each of the plurality of wireless nodes: determine quality metrics for the positioning measurements; select a subset of the positioning measurements based at least in part on the quality metrics associated with the positioning measurements; and determine the location of an access point based on the subset of the positioning measurements and the location estimates for the plurality of wireless nodes associated with the subset of the positioning measurements.

Clause 19. The apparatus of clause 18 wherein at least one of the quality metrics is an uncertainty value associated with the location estimate for at least one of the plurality of wireless nodes.

Clause 20. The apparatus of clause 18 wherein at least one of the quality metrics is a signal-to-noise ratio value of a received positioning measurement.

Clause 21. The apparatus of clause 18 wherein at least one of the quality metrics indicates a hardware configuration of at least one of the plurality of wireless nodes.

Clause 22. The apparatus of clause 18 wherein the at least one processor is further configured to compare the quality metrics to one or more threshold values to select the subset of the positioning measurements.

Clause 23. The apparatus of clause 18 wherein at least one of the plurality of wireless nodes is an user equipment.

Clause 24. The apparatus of clause 18 wherein at least one of the plurality of wireless nodes is an access point.

Clause 25. The apparatus of clause 18 wherein the at least one processor is further configured to: obtain a coarse location estimate for the access point; determine a bounding area around the coarse location estimate; and determine a quality metric for the positioning measurements based at least in part on an intersection with the bounding area.

Clause 26. The apparatus of clause 18 wherein the at least one processor is further configured to provide the subset of the positioning measurements to a server and receive the location of the access point from the server to determine the location of the access point.

Clause 27. The apparatus of clause 26 wherein the at least one processor is further configured to: measure one or more positioning reference signals transmitted from a transmission/reception point; and provide positioning reference signal measurement information to the server.

Clause 28. An apparatus, comprising: at least one memory; at least one transceiver; at least one processor communicatively coupled to the at least one memory and the at least one transceiver, and configured to: obtain positioning measurements from a plurality of wireless nodes: determine one or more quality metrics for each of the positioning measurements based at least in part on a measurement technology associated with a respective positioning measurement; compare the one or more quality metrics for each of the positioning measurements to one or more quality threshold values; and store a positioning measurement in response to the one or more quality metrics satisfying at least one quality threshold value.

Clause 29. The apparatus of clause 28 wherein the at least one processor is further configured to provide a stored positioning measurement to a server.

Clause 30. The apparatus of clause 28 wherein the at least one processor is further configured to obtain location estimates for each of the plurality of wireless nodes, wherein at least one of the one or more quality metrics is an uncertainty value associated with a location estimate for at least one of the plurality of wireless nodes.

Clause 31. The apparatus of clause 28 wherein at least one of the one or more quality metrics is a signal-to-noise ratio value of a positioning measurement.

Clause 32. The apparatus of clause 28 wherein at least one of the one or more quality metrics indicates a hardware configuration of at least one of the plurality of wireless nodes.

Clause 33. The apparatus of clause 28 wherein at least one of the plurality of wireless nodes is an user equipment.

Clause 34. The apparatus of clause 28 wherein at least one of the plurality of wireless nodes is an access point.

Clause 35. An apparatus for determining a location of an access point, comprising: means for obtaining positioning measurements from a plurality of wireless nodes; means for obtaining a location estimate for each of the plurality of wireless nodes; means for determining quality metrics for the positioning measurements; means for selecting a subset of the positioning measurements based at least in part on the quality metrics associated with the positioning measurements; and means for determining the location of the access point based on the subset of the positioning measurements and the location estimates for the plurality of wireless nodes associated with the subset of the positioning measurements.

Clause 36. An apparatus for prioritizing positioning measurements, comprising: means for obtaining positioning measurements from a plurality of wireless nodes; means for determining one or more quality metrics for each of the positioning measurements based at least in part on a measurement technology associated with a respective positioning measurement; means for comparing the one or more quality metrics for each of the positioning measurements to one or more quality threshold values; and means for storing a positioning measurement in response to the one or more quality metrics satisfying at least one quality threshold value.

Clause 37. A non-transitory processor-readable storage medium comprising processor-readable instructions configured to cause one or more processors to determine a location of an access point, comprising code for: obtaining positioning measurements from a plurality of wireless nodes; obtaining a location estimate for each of the plurality of wireless nodes; determining quality metrics for the positioning measurements; selecting a subset of the positioning measurements based at least in part on the quality metrics associated with the positioning measurements; and determining the location of the access point based on the subset of the positioning measurements and the location estimates for the plurality of wireless nodes associated with the subset of the positioning measurements.

Clause 38. A non-transitory processor-readable storage medium comprising processor-readable instructions configured to cause one or more processors to prioritize positioning measurements, comprising code for: obtaining positioning measurements from a plurality of wireless nodes: determining one or more quality metrics for each of the positioning measurements based at least in part on a measurement technology associated with a respective positioning measurement; comparing the one or more quality metrics for each of the positioning measurements to one or more quality threshold values; and storing a positioning measurement in response to the one or more quality metrics satisfying at least one quality threshold value.

1. A method for determining a location of an access point, comprising:
obtaining positioning measurement results based on radio frequency signals transmitted or received between the access point and a plurality of wireless nodes;
obtaining a location estimate for each of the plurality of wireless nodes;
determining quality metrics associated with the positioning measurement results;
selecting a subset of the positioning measurement results based at least in part on the quality metrics associated with the positioning measurement results; and
determining the location of the access point based on the subset of the positioning measurement results and the location estimates for the plurality of wireless nodes associated with the subset of the positioning measurement results.

2. The method of claim 1 wherein at least one of the quality metrics is an uncertainty value associated with the location estimate for at least one of the plurality of wireless nodes.

3. The method of claim 1 wherein at least one of the quality metrics is a signal-to-noise ratio value of a positioning measurement result.

4. The method of claim 1 wherein at least one of the quality metrics includes an indication of a hardware configuration of at least one of the plurality of wireless nodes.

5. The method of claim 1 wherein selecting the subset of the positioning measurement results includes comparing the quality metrics to one or more threshold values.

6. The method of claim 1 wherein at least one of the plurality of wireless nodes is an user equipment.

7. The method of claim 1 wherein at least one of the plurality of wireless nodes is an access point.

8. The method of claim 1 further comprising:
obtaining a coarse location estimate for the access point; and
determining a bounding area around the coarse location estimate, wherein determining the quality metrics for the positioning measurement results is based at least in part on an intersection of the positioning measurement results with the bounding area.

9. The method of claim 1 wherein determining the location of the access point includes providing the subset of the positioning measurement results to a server and receiving the location of the access point from the server.

10. The method of claim 9 further comprising:
measuring one or more positioning reference signals transmitted from a transmission/reception point; and
providing positioning reference signal measurement information to the server.

11-17. (canceled)

18. An apparatus, comprising:
at least one memory;
at least one transceiver;
at least one processor communicatively coupled to the at least one memory and the at least one transceiver, and configured to:
obtain positioning measurement results based on radio frequency signals transmitted or received between an access point and a plurality of wireless nodes;
obtain a location estimate for each of the plurality of wireless nodes;
determine quality metrics associated with the positioning measurement results;
select a subset of the positioning measurement results based at least in part on the quality metrics associated with the positioning measurement results; and
determine a location of the access point based on the subset of the positioning measurement results and the location estimates for the plurality of wireless nodes associated with the subset of the positioning measurement results.

19. The apparatus of claim 18 wherein at least one of the quality metrics is an uncertainty value associated with the location estimate for at least one of the plurality of wireless nodes.

20. The apparatus of claim 18 wherein at least one of the quality metrics is a signal-to-noise ratio value of a positioning measurement result.

21. The apparatus of claim 18 wherein at least one of the quality metrics includes an indication of a hardware configuration of at least one of the plurality of wireless nodes.

22. The apparatus of claim 18 wherein the at least one processor is further configured to compare the quality metrics to one or more threshold values to select the subset of the positioning measurement results.

23. The apparatus of claim 18 wherein at least one of the plurality of wireless nodes is an user equipment.

24. The apparatus of claim 18 wherein at least one of the plurality of wireless nodes is an access point.

25. The apparatus of claim 18 wherein the at least one processor is further configured to:
obtain a coarse location estimate for the access point;
determine a bounding area around the coarse location estimate; and
determine a quality metric for the positioning measurement results based at least in part on an intersection of the positioning measurement results with the bounding area.

26. The apparatus of claim 18 wherein the at least one processor is further configured to provide the subset of the positioning measurement results to a server and receive the location of the access point from the server to determine the location of the access point.

27. The apparatus of claim 26 wherein the at least one processor is further configured to:
measure one or more positioning reference signals transmitted from a transmission/reception point; and
provide positioning reference signal measurement information to the server.

28-30. (canceled)
